(19) United States
(12) Patent Application Publication
(10) Pub. No.: US 2026/0029421 A1
(43) Pub. Date: Jan. 29, 2026

(54) SAMPLE HANDLER WITH STATIONARY OPTICAL SENSOR AND MOVABLE OPTICAL ADAPTER FOR ADAPTING A SENSOR VIEW

(71) Applicant: Agilent Technologies, Inc., Santa Clara, CA (US)

(72) Inventors: Thomas Best, Karlsruhe (DE); Blasius Nocon, Rheinstetten (DE)

(21) Appl. No.: 18/575,296

(22) PCT Filed: Jun. 28, 2022
(86) PCT No.: PCT/IB2022/055985

§ 371 Date: Dec. 28, 2023

(30) Foreign Application Priority Data
Jun. 29, 2021 (GB) 2109351.3

(51) Int. Cl. G01N 35/10; G01N 30/24; G01N 35/00

(52) U.S. Cl. CPC G01N 35/1011; G01N 30/24; G01N 35/00732; G01N 2035/00752; G01N 2035/1025

(57) ABSTRACT

A sample handler for handling a sample container includes a stationary optical sensor, a movable stage movable with respect to the stationary optical sensor, and an optical adapter arrangeable at the movable stage and configured for being moved by the movable stage to thereby adapt a view of the stationary optical sensor.

### CROSS-REFERENCE TO RELATED APPLICATIONS

This application is the national stage under 35 U.S.C. 371 of International Application No. PCT/IB2022/055985, filed on Jun. 28, 2022; which claims priority to UK Application No. 2109351.3, filed on Jun. 29, 2021; the entire contents of which are incorporated by reference herein.

### TECHNICAL FIELD

The present invention relates to a sample handler, a sample separation apparatus, and a method of operating a sample handler for handling a sample container.

### BACKGROUND

In liquid chromatography, a fluidic sample and an eluent (liquid mobile phase) may be pumped through conduits and a separation unit such as a column in which separation of sample components takes place. The column may comprise a material which is capable of separating different components of the fluidic sample. The separation unit may be connected to other fluidic members (like a sampler or an injector, a detector) by conduits. Before the fluidic sample is introduced into a separation path between a fluid drive unit (in particular a high pressure pump) and the separation unit, a predefined amount of fluidic sample shall be intaken from a sample source (such as a sample container) via an injection needle into a sample loop by a corresponding movement of a piston within a metering device. Thereafter, an injector valve is switched so as to introduce the intaken amount of fluidic sample from the sample loop of a metering path into the separation path between the fluid drive unit and the separation unit for subsequent separation. As a result, the fluidic sample is injected into the mobile phase, such as a solvent or a solvent composition.

For injecting a fluidic sample as well as for fractionating a separated fluidic sample, sample handling is necessary.

However, sample handling is complex and in some cases inaccurate in conventional approaches.

### SUMMARY

It is an object of the present disclosure to enable sample handling in a simple and accurate way.

According to an exemplary embodiment of the present disclosure, a sample handler for handling a sample container is provided, wherein the sample handler comprises a stationary optical sensor, a movable stage being movable with respect to the stationary optical sensor, and an optical adapter arranged or arrangeable at the movable stage and configured for being moved by the movable stage to thereby adapt a view of the stationary optical sensor.

According to another exemplary embodiment, a sample separation apparatus for separating a fluidic sample is provided, wherein the sample separation apparatus comprises a fluid drive for driving a mobile phase and the fluidic sample when injected in the mobile phase, a sample separation unit for separating the fluidic sample in the mobile phase, and a sample handler having the above-mentioned features for handling a sample container containing fluidic sample.

According to still another exemplary embodiment, a method of operating a sample handler for handling a sample container is provided, wherein the method comprises arranging an optical sensor in a spatially fixed configuration, moving a movable stage with respect to the stationary optical sensor, and arranging an optical adapter at the movable stage for being moved by the movable stage to thereby adapt a view of the stationary optical sensor.

In the context of this application, the term “sample separation apparatus” may particularly denote any apparatus which is capable of separating different fractions of a fluidic sample by applying a certain separation technique, in particular liquid chromatography.

In the context of this application, the term “fluidic sample” may particularly denote any liquid and/or gaseous medium, optionally including also solid particles, which is to be analyzed. Such a fluidic sample may comprise a plurality of fractions of molecules or particles which shall be separated, for instance small mass molecules or large mass biomolecules such as proteins. Separation of a fluidic sample into fractions may involve a certain separation criterion (such as mass, volume, chemical properties, etc.) according to which a separation is carried out.

In the context of this application, the term “mobile phase” may particularly denote any liquid and/or gaseous medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a separation unit.

In the context of the present application, the term “fluid drive” may particularly denote an entity capable of driving a fluid (i.e. a liquid and/or a gas, optionally comprising solid particles), in particular the fluidic sample and/or the mobile phase. For instance, the fluid drive may be a pump (for instance embodied as piston pump or peristaltic pump) or another source of high pressure. For instance, the fluid drive may be a high-pressure pump, for example capable of driving a fluid with a pressure of at least 100 bar, in particular at least 500 bar.

In the context of the present application, the term “sample separation unit” may particularly denote a fluidic member through which a fluidic sample is transferred and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample.

In the context of the present application, the term “sample handler” may particularly denote a device or arrangement of devices configured for handling a fluidic sample and a sample container containing the latter, in particular before and/after separation of the fluidic sample in a sample separation apparatus. This may include in particular sample handling prior to injecting a fluidic sample for sample separation, and/or sample handling in terms of fractionating a separated fluidic sample. For instance, such a sample handler may be implemented in a sample separation apparatus (such as a chromatographic separation device).

In the context of the present application, the term “sample container” may particularly denote a container configured for accommodating one or a plurality of fluidic samples. For example, a sample container may be a sample vial containing one fluidic sample, when the sample vial may or may not be closed on its top side with a removable or pierceable cover layer. It is however also possible that the sample container is a device configured for containing a plurality of fluidic samples. In one embodiment, such a sample container may have a plurality of accommodation volumes, each configured for accommodating a respective fluidic sample directly. In another embodiment, such a sample container may have a plurality of accommodation volumes, each configured for accommodating a small sample container (such as a sample vial) containing, in turn, a fluidic sample. For instance, a sample container containing multiple fluidic samples may be a microtiter plate, a well plate or a vial tray.

In the context of the present application, the term “stationary optical sensor” may particularly denote an optical sensor being arranged stationary fixed in a sample handler, i.e. being free of any moving mechanism. Hence, a stationary optical sensor may remain at a fixed position and/or in a fixed orientation during operation of a sample handler, in particular fixed in a lab system. An optical sensor or optical detector may be any physical entity configured for sensing information by electromagnetic radiation (in particular visible light, infrared radiation and/or ultraviolet radiation) propagating between the optical sensor and a region of interest, for instance a device, or part of a device, to be inspected. For example, such an optical sensor may be a single photocell (such as a photodiode), a linear or one-dimensional arrangement of photocells, or a two-dimensional optical sensing array (for instance a camera, more specifically a CCD (charge coupled device) camera or a CMOS (complementary metal oxide semiconductor) camera).

In the context of the present application, the term “movable stage” may particularly denote a stage being movable within a sample handler, i.e. having or cooperating with a moving mechanism configured for changing a position and/or an orientation of the movable stage. For instance, a movable stage may be movable in a translatory way and/or in a rotational way. The movable stage may be movable relative to a lab system. The mentioned stage may be a platform or carrier configured for carrying at least one member thereon, such as a sample container and/or an optical adapter. The movable stage may be configured to cooperate with other constituents of a sample handler, for instance a sample needle.

In the context of the present application, the term “optical adapter” may particularly denote any optical member configured for carrying out an optical adaptation of the sample handler. In particular, the optical adapter may be optically coupled or couplable with the optical sensor so that an electromagnetic radiation beam may propagate between optical adapter and optical sensor. The optical adapter may comprise one or more passive and/or active optical elements or components. In this context, passive optical elements may for example be an optical mirror or reflector, a beam shaping element, an optical lens, an optical collimator, a diffraction grating, an optical monochromator and/or an optical filter. Active optical elements may for example be an optical camera or a motor-driven optical element.

In the context of the present application, the term “adapt a view of a stationary optical sensor” may particularly denote the capability of the movable adapter for selecting or adjusting a viewing direction (such as a viewing angle) or a spatial area being viewed by the optical sensor. The mentioned adaptation of the optical view of the optical sensor may be accomplished by a motion (for instance rotation) of the movable stage, so that motion may allow to adjust or modify an optical path from the optical sensor via the optical adapter towards a point or region of view, and/or in opposite direction. The mentioned optical path may be straight or angled (which may be preferred in some embodiments).

According to an exemplary embodiment of the present disclosure, a sample handler may be equipped with a stationary optical sensor and a movable stage as well as with an optical adapter on the movable stage, the latter being movable for adapting or modifying a viewing direction and/or a spatial or angular range of the stationary optical sensor. By taking this measure, it may be possible to provide an optical sensor fixed rather than movable, which significantly simplifies construction of the sample handler. Only a stage, which may for instance carry the optical adapter and optionally also a sample container, is provided in a movable way and can be moved for changing a field of view of the stationary optical sensor. This may make it possible that the optical sensor can detect sensor data from a handled sample container from different directions or from different surface areas thereof (for instance selectively from a bottom side and/or from a lateral side). Additionally or alternatively, such a configuration may allow the stationary optical sensor to monitor a portion of or even the entire sample handler, for instance for detecting potential issues (such as leakage or a damaged sample needle). Furthermore, such a stationary camera in combination with a movable optical adapter may also allow to obtain information concerning an environment or interface of the sample handler (for instance new samples to be treated by the sample handler and being provided by a user or an automated entity). Hence, a sample handler with a stationary camera functionally cooperating with one or more movable optical adapters (for example via a sample turntable) may be provided, thus allowing to adjust an adaptive view while keeping the number of movable elements very small. This may enable sample handling in a simple and accurate way.

In the following, further embodiments of the sample handler, the sample separation apparatus, and the method will be explained.

In an embodiment, the movable stage is configured for carrying and moving one or more sample containers (in particular a sample vial containing fluidic sample, a well plate, and/or a vial tray comprising one or more vials containing fluidic sample). By moving, the movable stage may for example locate a sample container at a target position in relation to an injection needle for intaking fluidic sample from the sample container. In particular, the movable stage may carry at least one sample container and/or the optical adapter, simultaneously or sequentially.

In an embodiment, the movable stage comprises a turntable configured for turning the sample container together with the optical adapter. Thus, the movable stage may be rotatable, and the optical adapter may be arranged detachably or non-detachably to rotate together with the movable stage. Furthermore, at least one sample container may be arranged detachably or non-detachably to rotate together with the movable stage. Additionally or alternatively to a rotating motion, the movable stage may also carry out a longitudinal motion.

In an embodiment, the movable stage is configured for rotating the optical adapter. This can be accomplished by detachably mounting the optical adapter on a rotatable stage or by integrally forming the optical adapter with a rotatable stage. Moving the optical adapter together with the movable stage may allow to accomplish the motion of the optical adapter without providing an additional motion mechanism. A motion mechanism for moving sample containers on the movable stage may be used also for moving the optical adapter. For example, an optical mirror (or another object adapter) may be brought in and out of optical interaction with the optical sensor, so that a viewing direction of the optical sensor may be switched between two different configurations by bringing the optical mirror (or more generally the optical adapter) in optical interaction with the optical sensor (which may lead to an angled optical path) or out optical interaction with the optical sensor (which may lead to a straight optical path). In yet another embodiment, the optical adapter may be moved and in particular rotated separately from the movable stage.

In an embodiment, the optical adapter and/or the sample container is or are detachably arranged or arrangeable at the movable stage. This may increase the flexibility of a user for using a movable stage, such as a turntable, since it may allow a user to freely select an assembly of one or more mounting provisions for mounting optical adapters and/or sample containers on the movable stage.

In an embodiment, the optical adapter comprises or consists of at least one passive optical component (i.e. optical components operable without energy supply, in particular without electric energy supply). Examples for passive optical components are an optical mirror or reflector, a beam shaping element, an optical lens, an optical collimator, a diffraction grating, an optical monochromator and/or an optical filter. The optical adapter may have only one or more passive optical components, but no active optical components. This significantly simplifies construction of the optical adapter, since in particular no electric cable connection is necessary.

However, in another embodiment, the optical adapter may also comprise at least one active optical element, such as an optical camera and/or a motor-driven optical element.

In an embodiment, the optical adapter comprises at least one mirror. The implementation of a reflective mirror as optical component of the optical adapter is a simple and failure-robust embodiment which allows to adapt a view of the stationary optical sensor in a simple way. In an embodiment, the movable stage may move the optical adapter between two configurations with respect to the stationary optical sensor, one in alignment with the mirror and another one out of alignment with the mirror.

In an embodiment, the optical sensor is configured as camera, in particular as one of the group consisting of a CMOS camera and a CCD camera. Such a camera may provide a two-dimensional array of optically sensitive pixels and may provide optical information concerning a spatial range or area. In other embodiments, a very simple optical sensor consisting only of a single photocell (such as a photodiode) may be sufficient, for instance for detecting a one-bit optical signal.

In an embodiment, the optical sensor is configured for sensing the sample container. Thus, at least in one configuration of the optical adapter and the optical sensor, the optical sensor may sense a surface region of the sample container. It may also be preferred that, in different configurations of the optical adapter and the optical sensor, the optical sensor senses two or more than two different surface regions of the sample container (for instance a bottom surface of the sample container for identifying a first code, a side surface of the sample container for identifying a second code, and fluidic sample in the sample container for assessing integrity of the fluidic sample).

In an embodiment, the optical sensor is configured for sensing at least one code on the sample container. For instance, such a code may be a barcode (in particular a one dimensional linear barcode or a two-dimensional QR code) or an alphanumerical code on the sample container. However, the code may also be a hologram, a multi-color code, etc.

In an embodiment, the optical sensor is configured for sensing the at least one code on the sample container via the optical adapter. For example, a light beam may propagate from the code on the sample container through the optical adapter towards the optical sensor. Such a beam path may be in particular angled (for instance when the optical adapter comprises a reflective mirror).

In an embodiment, the optical sensor is configured for sensing a code (such as a linear barcode or a QR code) on a bottom surface and/or a code (such as a linear barcode or a QR code) on a side surface of the sample container. Sensing the bottom surface and sensing the side surface of the sample container may correspond to two different configurations of the optical sensor with respect to the optical adapter and with respect to the sample container. In another embodiment, it is also possible to detect a plurality of codes on different surface portions of a sample container simultaneously.

In an embodiment, the optical sensor is configured for sensing a property of the sample handler or a component thereof, in particular a needle and/or a needle seat. Additionally or alternatively to the characterization of a sample container and/or a fluidic sample contained therein by the optical sensor in cooperation with the optical adapter, such an exemplary embodiment may provide optical sensing information characterizing at least a part of the sample handler by the optical sensor cooperating with the optical adapter. In particular, the optical adapter may be brought in such a configuration that electromagnetic radiation (such as light) indicative of an image of at least part of the sample handler propagates via the optical adapter to the optical sensor. By taking this measure, it may be in particular possible to identify an issue with the sample handler, for instance a deformed needle, an undesired solid-state precipitation at the needle seat, a leakage (for instance at a seat-needle-interface), etc.

In an embodiment, the optical sensor is configured for sensing a property of a fluidic sample in the sample container, in particular an opacity, a precipitation and/or a contamination. Thus, the optical sensor in cooperation with the optical adapter may also identify at least one property of the fluidic sample in the sample container by evaluating an optical image thereof. For instance, this may identity issues such as an opacity, a contamination, a solid precipitation, etc., in the fluidic sample which may render the fluidic sample inappropriate for a subsequent separation thereof. If such an undesired event is identified, a corresponding action may be taken (for instance stopping of an injection and/or separation process, outputting a warning to a user, etc.).

In an embodiment, the sample container forms part of the sample handler. In particular, such a sample container may comprise at least one of a group consisting of a sample vial, a well plate, and a vial tray. A sample vial may contain the fluidic sample directly therein and can be placed, for example, in a vial tray. A vial tray may for example be a sample container having a plurality of (for example matrix-like arranged) compartments, each configured for accommodating a respective sample vial (filled with a fluidic sample therein). A well plate may be a sample container having a plurality of (for example matrix-like arranged) compartments, each accommodating a fluidic sample directly therein. Other sample containers are possible.

In an embodiment, the movable stage carries or is configured to carry both the sample container and the optical adapter, in particular having the same footprints. More specifically, shape and/or dimensions of a bottom portion of the sample container and the optical adapter may correspond to each other so that a sample container or an optical adapter may be mounted selectively and substitutably on each mounting provision at the movable stage (for instance a turntable).

In an embodiment, the optical sensor has a vertical viewing axis. In other words, a sensor surface being sensitive to electromagnetic radiation such as visible light may be arranged so that electromagnetic radiation propagating along a vertical direction may be sensed by the optical sensor. For instance, the viewing direction of the optical sensor may be so that light propagating vertically downwardly may be sensed by the optical sensor.

In an embodiment, the optical sensor is arranged below the movable stage. Light may then propagate from a region of interest corresponding to a present field of view of the optical sensor (for instance from a sample container, from a fluidic sample in a sample container, and/or from a component of the sample handler or a sample separation apparatus) selectively through the optical adapter, and to the optical sensor for sensing. It may be desirable to have a vertical viewing axis of the optical sensor in combination with a location of the optical sensor below the movable stage. This may properly protect the optical sensor from damage or misalignment while ensuring an extended range of optical views accessible for the optical sensor.

In an embodiment, the optical sensor comprises a movable protection cover being actuatable, in particular by a pusher mounted on the movable stage or on the optical adapter, for selectively covering the optical sensor in a passive protection mode or for exposing the optical sensor in an active sensing mode. In an optically passive mode, the protection cap may cover a lens of the optical sensor for protecting the optical sensor from contamination and mechanical impact. In an optically active mode, the protection cap may be slid or pivoted away from the lens of the optical sensor for exposing the latter to detect sensing data. Advantageously, a pusher may convert the optical sensor between a covered and an uncovered mode by actuating its cover. Further advantageously, the pusher may form part of the movable stage so that moving the movable stage may actuate the cover via the pusher. Advantageously, no additional motion mechanism is then necessary for operating the pusher, which may allow to implement the protection feature with low effort.

In an embodiment, the sample handler comprises a cleaning unit, in particular at least one brush and/or at least one squeegee, configured for moving relative to the optical sensor to mechanically impact the optical sensor for cleaning. A cleaning element (such as a brush or a squeegee) may be moved along a sensor active surface or a lens of the optical sensor for removing contamination particles, condensed moisture, etc. Advantageously, the cleaning element may form part of the movable stage so that moving the movable stage may guide the cleaning element along the optical sensor for cleaning the latter. Hence, no additional motion mechanism is necessary for operating the cleaning element, which may allow to implement the cleaning feature with low effort.

In an embodiment, the sample handler is configured as injector for injecting a fluidic sample from the sample container. For instance, such an injector may comprise a needle being movable by a robot or the like to immerse the needle into a fluidic sample in a sample container. Thereafter, fluidic sample may be aspirated through the needle into a sample loop of the injector. This intake process may be carried out by withdrawing a piston of a metering device. Thereafter, the needle may be driven in a needle seat, and the aspirated fluidic sample may be injected from the sample loop into a separation path between a fluid drive and a sample separation unit (such as a chromatographic separation column). By providing an injector with a stationary optical sensor cooperating with an optical adapter on a movable stage, the injection process can be controlled more precisely and the data basis for such an injection process can be broadened. For instance, the injector may be configured for controlling injection of the fluidic sample based on information sensed by the optical sensor.

In another embodiment, the sample handler is configured as fractioner or fractionating unit configured to collect a separated fluidic sample in the sample container. After separating a fluidic sample in fractions in a sample separation apparatus, the separated fractions may be filled in different sample vials or other sample containers. For example, the separated fractions downstream of a sample separation unit or of a detector may be guided through a fractionating needle into sample containers. By providing a fractionator with a stationary optical sensor cooperating with an optical adapter on a movable stage, the fractionating process can be controlled more precisely and the data basis for such a fractionating process can be broadened.

In an embodiment, a control unit is provided and configured for identifying, using and/or storing information, in particular information included or encoded in at least one code of the sample container, sensed by the optical sensor for tracking at least one of a group consisting of the sample container, a fluidic sample in the sample container, and a sample separation process. As already described above, the optical sensor (such as in cooperation with the optical adapter) of the sample handler may be configured for reading at least one code (such as a QR code or a linear barcode) from a sample container, and may be in particular configured for reading different such codes from different surface portions (in particular at a bottom surface and at a lateral surface) of a sample container. Such information may be read by the optical sensor and may be stored in a database. Consequently, a sample handling process carried out or controlled by the sample handler (in particular an injection process and/or a fractionating process) may be precisely tracked based on information stored in the database. Thus, the operation safety as well as the degree of documentation of a sample handling process may be improved by taking this measure.

In an embodiment, the sample handler comprises or consists of a sample container holder having an accommodation volume for accommodating at least part of the sample container and having an internal optical configuration enabling the optical sensor for sensing a sample container when accommodated in the accommodation volume. The sample container holder may have an optically reflective inner surface for reflecting electromagnetic radiation propagating between the sample container and the optical sensor. In particular, the sample container holder may be an annular body having a central opening defining the accommodation volume. In an embodiment, the internal optical configuration of the sample container holder comprises a reflective mirror cone. For example, the sample container holder may be configured for receiving the sample container from above, whereas the optical sensor is arranged below the sample container holder. Advantageously, the optical sensor may be configured for sensing at least one code, in particular for sensing simultaneously a plurality of codes, on a bottom surface and/or on a side surface of the sample container when accommodated in the accommodation volume. An embodiment of the mentioned sample container holder is shown in FIG. 8 to FIG. 10.

For example, the sample container holder may have at least one further accommodation volume for accommodating at least part of at least one further sample container and may have an internal optical configuration enabling the optical sensor or at least one further optical sensor for sensing at least one further sample container when accommodated in the at least one further accommodation volume. An embodiment of the mentioned sample container holder is shown in FIG. 11.

The mentioned sample container holder may be the above described optical adapter. The sample container holder may synergistically combine the functionality of the optical adapter with the functionality of a sample container, since a sample vial or the like may be held in the sample container holder in addition to its optical function.

In an embodiment, the sample handler may comprise a plurality of optical adapters, for instance of the above described type. Different optical adapters may be integrated in a single body or may be provided as separate bodies. This may make it for instance possible that in different motion states of the movable stage, different optical adapters may be brought in optical alignment with the stationary optical sensor. Advantageously, the described configuration may support different viewing directions, viewing areas and/or viewing angles of the stationary optical sensor when cooperating with different optical adapters. Consequently, the basis of sensed information may be further broadened.

In yet another embodiment, it is also possible to provide a plurality of stationary optical sensors.

In an embodiment, the optical sensor may comprise or may cooperate with an electromagnetic radiation source, such as a light source. Thus, light may be actively emitted by the light source and may propagate through a field of view of the stationary optical sensor, for instance to at least a portion of a sample container, at least a portion of the fluidic sample in a sample container and/or to at least a portion of the sample handler. The light may then propagate back towards the optical sensor for optical sensing. By providing an additional light source, meaningful optical signals may be detected by the optical sensor even under poor illumination conditions.

Embodiments may be implemented in conventionally available HPLC systems, such as the analytical Agilent 1290 Infinity II LC system or the Agilent 1290 Infinity II Preparative LC/MSD system (both provided by the applicant Agilent Technologies—see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump may be configured to know (by means of operator's input, notification from another module of the instrument or similar) or elsewise derive solvent properties.

The sample separation unit of the sample separation apparatus may comprise a chromatographic column (see for instance en.wikipedia.org/wiki/Column_chromatography) providing a stationary phase. The column may be a glass or steel tube (for instance with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation water and organic solvent are delivered in separate bottles, from which the gradient pump delivers a programmed blend to the system. Other commonly used solvents may be isopropanol, tetrahydrofuran (THF), hexane, ethanol and/or any combination thereof or any combination of these with aforementioned solvents.

A fluidic sample analyzed by a sample separation apparatus according to an exemplary embodiment of the present disclosure may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation apparatus, for instance an HPLC system, may further comprise a detector for detecting separated compounds of the fluidic sample, a fractionating unit for outputting separated compounds of the fluidic sample, or any combination thereof. For example, a fluorescence detector may be implemented.

Embodiments of the present disclosure can be partly or entirely embodied or supported by one or more suitable software programs, which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) can be applied in or by the control unit, e.g. a data processing system such as a computer, preferably for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

### BRIEF DESCRIPTION OF DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 shows a liquid sample separation apparatus in accordance with embodiments of the present disclosure, particularly used in high performance liquid chromatography (HPLC).

FIG. 2 shows a schematic view of a sample handler according to an exemplary embodiment of the present disclosure implementable in the sample separation apparatus of FIG. 1.

FIG. 3 shows a liquid sample separation apparatus implementing an injector in accordance with embodiments of the present disclosure, particularly used in high performance liquid chromatography (HPLC).

FIG. 4 shows a three-dimensional view of a sample handler according to an exemplary embodiment of the present disclosure.

FIG. 5 shows a side view of a sample handler according to an exemplary embodiment of the present disclosure.

FIG. 6 shows a top view of a sample handler according to FIG. 5.

FIG. 7 shows a top view of a sample handler according to another exemplary embodiment of the present disclosure.

FIG. 8 shows a three-dimensional view of a sample container holder for a sample handler according to an exemplary embodiment of the present disclosure.

FIG. 9 shows a cross-sectional view of the sample container holder of FIG. 8 together with an optical sensor.

FIG. 10 shows an optical pattern sensed by the optical sensor of FIG. 9.

FIG. 11 shows a plan view of a sample container holder for a sample handler according to another exemplary embodiment of the present disclosure.

FIG. 12 shows a vial-type sample container with a code on a side surface and on a bottom for a sample container holder according to an exemplary embodiment of the present disclosure.

FIG. 13 shows a vial-type sample container with a code on a bottom and on a side surface for a sample container holder according to an exemplary embodiment of the present disclosure.

FIG. 14 shows a well plate-type sample container with a code on a side surface and a further code on a further side surface for use in combination with an optical sensor and an optical adapter of a sample handler according to an exemplary embodiment of the present disclosure.

FIG. 15 and FIG. 16 show three-dimensional views of a sample handler according to another exemplary embodiment of the present disclosure.

FIG. 17 shows a plan view of the sample handler of FIG. 15 and FIG. 16.

FIG. 18 shows a plan view of a sample handler according to another exemplary embodiment of the present disclosure.

FIG. 19 show a side view of the sample handler according to FIG. 18.

FIG. 20 shows a plan view of a sample handler according to still another exemplary embodiment of the present disclosure.

FIG. 21 show a side view of the sample handler according to FIG. 20.

The illustrations in the drawing are schematic.

### DETAILED DESCRIPTION

Before describing the figures in further detail, some basic considerations of the present present disclosure will be summarized based on which exemplary embodiments have been developed.

For tracking reasons, sample vials can have codes. These codes may be located on the bottom (for instance two-dimensional codes like a QR-code or a data matrix) or on the side of a sample vial (for example one-dimensional or two-dimensional barcodes). Conventional approaches focus on one type of code location. Readers for the bottom variant just use a camera to take a picture of the bottom of the vial. Readers for the side variant use laser scanners or camera systems. In such conventional configurations, the vials have to be placed in the right orientation into a vial holder or the system needs a vial gripper that can carry the vial to the scanner and rotate the vial to the appropriate code position. This setup is complex and time consuming, and only one vial can be scanned at the same time.

Another conventional HPLC-sampler has a code reader for barcodes on the side of well plates integrated in an instrument.

According to an exemplary embodiment of the present disclosure, a sample handler may be provided with an optical adapter (for instance an optical mirror) on a movable stage, such as a turntable. By taking this measure, moving the optical adapter with respect to a spatially fixed optical sensor may allow to change an angular and/or spatial region of view of the optical sensor, for instance by reflecting light at the adjustable optical adapter. For instance, this may allow the optical sensor to detect information from a sample container and/or a fluidic sample in a sample container and/or a component of the sample handler from different viewing angles or directions. Advantageously, this may enable a comprehensive inspection of a sample handling process. Such a sample handler may be implemented in a sample separation apparatus, such as a liquid chromatography device, more specifically in an injector (for intaking and injecting a fluidic sample for subsequent sample separation) and/or in a fractionator (for fractionating separated portions of the fluidic sample) thereof. This may simplify a sample handling process (since the sample handler may be operated automatically, and a user action may be optional), and may render the sample handling process more accurate (by broadening the basis of information for controlling the sample handler).

For instance, an optical mirror type optical adapter or any other optical adapter may be attached at a sample container accommodation provision at the mounting stage, so that selectively an optical adapter or a sample container (such as a microtiter plate or a vial tray) may be attached to the sample container accommodation provision of the movable stage. It is however possible that the optical adapter is arranged elsewhere on, above or below the movable stage. In another embodiment, an optical adapter (which may include an optical mirror) may be integrally formed with the movable stage (for instance integrated in the bottom wall thereof). In another embodiment, it is also possible that the optical adapter itself comprises the or an optical sensor, or an additional optical sensor.

In one embodiment, the optical adapter comprises one optical element, such as one mirror. In other embodiments, the optical adapter comprises a plurality of optical elements, for instance a plurality of mirrors. The at least one optical element of the optical adapter may comprise a passive optical clement (such as a mirror) and/or an active optical element (such as an optical sensor). The provision of the optical adapter with one or more passive optical elements only may be desirable, since this may render cable connections to the optical adapter dispensable and may allow to provide the entire motion resources by the movable stage on which the optical adapter may be mounted or arranged.

By providing the sample handler with an optical adapter capable of modifying or varying a field of view of the optical sensor depending on its position and/or orientation relative to the stationary optical sensor, it may be possible to detect information from different surface portions of a sample container and/or information from the sample container and the fluidic sample contained therein by merely changing the position and/or orientation of the optical adapter. For instance, this may make it possible to detect different barcodes at different surface portions (for instance a bottom surface and a lateral surface) of a vial-type sample container. The detected information can for instance be used for controlling a sample handling process (in particular a sample injection process and/or a sampler fractionating process) and may also be used (in particular stored) for documenting a sample handling process (in particular for tracking purposes).

By implementing an optical adapter (such as an mirror) in the sample handler, it may for instance be possible to detect optically that new sample containers (for instance new vials with fluidic sample therein) have been provided (for example by a user or a robot) to be processed. This information may then be used for controlling the sample handling process accordingly, for instance for gripping such sample containers subsequently and injecting the corresponding fluidic sample in a sample separation apparatus for sample separation. In another embodiment, the detected optical information may also allow to identify an issue with the sample handler or any other viewable component of a sample separation apparatus. Thus, the sample container or a sample separation apparatus as a whole may use the optically detected information for self-diagnosis. For instance, the optically detected information may be used for identifying that a component of the sample handler (for instance an injector) has an issue (for instance a leakage of fluidic sample, undesired salt precipitation at a needle seat and/or a deformed sample intake needle). Thus, the optically detected information which can be extended by increasing the field of view of the stationary optical sensor due to the movable optical adapter can be used for predictive maintenance purposes and/or for proposing maintenance of the sample handler to a user.

It is also possible that optical information detected from a fluidic sample in a sample container may be used for assessing suitability of the fluidic sample for processing, in particular for subsequent separation. For instance, a potential opacity of the fluidic sample may be detected, as well as precipitation in the sample. Also a contamination of the fluidic sample may be detected optically. These events may be indicators for inappropriate fluidic sample properties. A sample separation process may be controlled in accordance with the results of the optical inspection of the fluidic sample (in particular may be carried out, may be stopped, or a warning may be output to a user).

For example, a self-check of the sample handler (what concerns integrity of the sample handler itself and/or integrity of a fluidic sample to be handled by the sample handler) may be carried out before sample handling. In an embodiment, an intended sample handling process is only released after successful completion of the self-check.

According to exemplary embodiment of the present disclosure, an autosampler is provided which comprises a stationary optical sensor and a movable stage. The movable stage may be configured for detachably receiving at least one optical adapter configured for redirecting an optical path. Moreover, the at least one optical adapter may be relocated in order to adjust the field of view of the stationary optical sensor. In particular, an optical component or adapter may be located on a carousel and may be arranged to be movable or to move along with the carousel. Thus, the optical sensor or camera including its viewing direction may remain spatially fixed, while one or more optical components of an optical adapter may be moved to render a field of view of the optical sensor variable and accessible for an object to be scanned (which may be a fluidic sample in a sample container, the sample container thereof, and/or a constituent of the sample handler or the sample separation apparatus).

In particular, a detachable optical adapter or module may be provided and may be configured for obtaining information. For example, such information may be detected from one or more barcodes, counts of consumables, images of moving parts, etc. The detachable optical adapter or module may have a footprint as a detachably mountable sample container (like a microtiter plate or a well-plate for an HPLC sampler) in order to fit into a sample container accommodation provision (such as a well-plate slot) of a sample handler or sampler. The optical adapter or module may comprise an optically sensible sensor element or camera to capture images or the like or may just comprise mirrors or other passive optical elements to redirect the optical path to the optical sensor (such as a sensor element or a camera) having a fixed location and viewing direction in the sample handler or sampler. By rotating a carousel of a movable stage, the optical adapter or module may be repositioned in order to scan one or more components, which could not be scanned from the initial position, i.e. before moving (in particular rotating).

Exemplary embodiments of the present disclosure may be implemented in any laboratory instrument, in particular in an HPLC. An embodiment may comprise one or more vision systems (such as an optical camera), sensors and/or optics for obtaining information accessible from exterior. In particular, such information may be optically detected from barcodes, counts of consumables, images of moving parts, etc. Advantageously, moving an optical adapter on a movable stage relative to a stationary optical sensor may allow to redirect an optical path or field of view by appropriate optics of the optical adapter, which may include one or more mirrors.

In particular, an embodiment may comprise a detachably mounted optical adapter or optics module comprising a vision system or sensors and other optical components as for instance mirrors configured for obtaining information, for example, from barcodes, counts of consumables, images of moving parts etc., accessible at or in a laboratory instrument. In an embodiment, the optical adapter or optics module may have no direct optical path to access the information.

A detachably mounted optical adapter or optics module may have a footprint as like a sample container (such as a microtiter plate or a well-plate) of an HPLC sampler in order to fit into a mounting provision (such as a well-plate slot) of the sampler or sample handler.

In an embodiment, a sample handler configured as autosampler for an HPLC is provided having a movable stage which is turntable. A spatially fixed optical sensor may be provided and may be embodied as CMOS camera or CCD camera. An optical adapter may also be provided which, in an embodiment, comprises only one or more passive optical elements and no active optical elements. In embodiments, such a configuration may make it possible to inspect or read barcodes from a side surface and/or from a top surface of a sample container (such as a sample plate or a sample vial). Additionally or alternatively, this may make it possible to inspect one or more instrument components, in particular in terms of instrument diagnosis. For example, this may allow to detect events such as condensation on an instrument (for instance a wall, a door, or other surfaces of a housing), bending of an injection needle, and the presence of dirt or dust. The movable stage may be configured for receiving the at least one optical adapter and at least one sample container (such as a sample plate). Furthermore, an attachment mechanism for an optical adapter may be provided at a movable stage. A footprint and shape of the optical adapter and of a sample container (such as a sample plate) may be identical or substantially the same.

In different embodiments, different designs of the optical adapter may be used for different purposes or instruments, in accordance with the desired function. For example, the optical adapter can be used with a stationary stage configured for detachably receiving at least one optical adapter. The optical adapter may include an active optical element like an optical sensor or camera. An accommodation provision (such as a slot) for receiving such an optical adapter may include electrical connections for powering the optical adapter and/or for transferring data. The optical adapter may include a battery to power an active optical element thereof. The battery included by the optical adapter may be chargeable by a connection to a charging cable, by attaching the optical adapter to an external charging station, and/or by attaching the optical adapter to the sample handler or any other instrument including electrical connections (i.e. charging via the sample handler or any other instrument). The optical adapter may comprise electronics for wireless data transfer (by for example Bluetooth, RFID, and/or WLAN). Moreover, the optical sensor may be configured for inspecting a sample container (such as a sample plate and/or sample vials) from the bottom, in particular for reading barcodes at the bottom of a sample container (in particular sample vials). The optical adapter may comprise adjustable mirrors (for example adjustable by an actuator, a motor, etc.). The optical adapter may comprise a housing for protecting the optical elements from dirt and/or dust and fluids (such as liquids, aerosols and/or gases), which may include harsh solvents.

According to an exemplary embodiments, one or more rotatable handlers may be provided for interacting with a (in particular rotatable) turntable for sampling.

According to another exemplary embodiment, which can be provided separately from or combined with the previously described embodiment, a barcode reader may be arranged in a turntable sample arrangement.

In an embodiment, which can however be optionally combined with any of the two aforementioned embodiments, a stationary camera may be provided in functional collaboration with a movable optical adapter (for example movable via a sample turntable on which the optical adapter may be mounted), thus allowing an adaptive view of the optical sensor via the optical adapter towards a direction, an angle and/or a region of interest.

According to an exemplary embodiment of the present disclosure, a camera setup for barcode reading and inspection features in a rotary autosampler may be provided. A corresponding sample handler may comprise a universal code reader for sample containers and sample vials of any kind with the option to include additional inspection features.

In particular, an exemplary embodiment of the present disclosure may integrate one or more of the following features into an HPLC autosampler: A code reader (for instance for reading QR code, a data matrix, and/or a one-dimensional barcode) may be provided for reading codes that are placed on the bottom of a sample vial. However, an exemplary embodiment may also implement a code reader for a code placed on the side surface of a sample vial. Furthermore, exemplary embodiments may use a stationary optical sensor in combination with a movable optical adapter for sample inspection, for instance to check the opacity and/or the liquid level of the sample. When the sample handler (for instance an autosampler) is configured as a fraction collector, it can also be used to monitor filling information (in particular filling levels of vessels). In yet another embodiment, it may be possible to detect that a new sample was brought into the sample handler or sampler and where it was placed (in particular, it may be possible to monitor whole sample plates or trays or fixed sample positions on a turntable of the sampler). In an embodiment, a code reader for reading codes may be provided that are placed on one or both sides and/or on the bottom of a sample container (such as a well plate or a sample tray). In yet another embodiment, the sample handler may be configured for monitoring an injection process by correspondingly adapting a viewing angle of the optical sensor by a corresponding position and/or orientation of the optical adapter. A further embodiment may allow to optically monitor if a sample vial was placed in an external sample tray (if the sample was brought by an external robot or automation interface to the external vial tray of the autosampler). Additionally or alternatively, it may be possible to detect if a whole well plate or tray was placed at the entry of the automation interface of the sample handler, configured as autosampler. Furthermore, a cover and/or cleaning mechanism for one or more optical parts (in particular of the optical adapter) may be provided) that requires no additional actuators. For instance, such a cover may be operated and/or such a cleaning mechanism may be actuated by the motion of the movable stage.

Exemplary embodiments of the present disclosure have advantages: Contrary to conventional approaches, one or more additional inspection features may be integrated in an HPLC autosampler by optically coupling a stationary optical sensor with a movable optical adapter for flexibly adjusting a viewing angle and/or a spatial range of the optical sensor. In particular, several optical features may be provided by the provision of only one stationary optical sensor (such as a camera) collaborating with a movable optical adapter, wherein no additional actuators may be needed. All moving parts may already be implemented in the autosampler itself.

Optionally, an additional gripper may be provided for a vial based sample inspection and reading of codes on the sides of sample vials. When providing a sample container holder (sec for example FIG. 8 to FIG. 10), any need for a gripper arm that can rotate vials with barcodes that are placed on the side of sample vials (or other sample containers) may be dispensable. This may improve a possible sample inspection feature as the sample can be examined from all sides (including a bottom view). In embodiments, a sample container holder can also be integrated in a vial tray or in the movable stage (such as a turntable) itself.

Advantageously, one or more optical parts (in particular the optical adapter or at least part thereof) of the sample handler can be protected against the environment with a cover that can be moved with an actuator being already present for moving the movable stage. Thus, no complex movements of the robotics are necessary which leads to a very fast approach to the different tasks.

Referring now in greater detail to the drawings, FIG. 1 depicts a general schematic of a liquid separation system as example for a sample separation apparatus 10 according to an exemplary embodiment of the present disclosure. A fluid drive 20 (such as a piston pump) receives a mobile phase from a solvent supply 25 via degassing unit 27, which degases and thus reduces the amount of dissolved gases in the mobile phase. The fluid drive 20 drives the mobile phase through a separation unit 30 (such as a chromatographic column) comprising a stationary phase. A sampler or injector 40, implementing a fluidic valve 95, can be provided between the fluid drive 20 and the separation unit 30 in order to subject or add (often referred to as sample introduction) a sample fluid into the mobile phase so that a fluidic sample and mobile phase may be provided towards a separation path where actual sample separation occurs. The stationary phase of the separation unit 30 is configured for separating compounds of the sample liquid. A detector 50 is provided for detecting separated compounds of the sample fluid. A fractionating unit 60 can be provided for outputting separated compounds of sample fluid in sample containers 102.

While the mobile phase can be comprised of one solvent only, it may also be mixed from plural solvents. Such mixing might be a low pressure mixing and provided upstream of the fluid drive 20, so that the fluid drive 20 already receives and pumps the mixed solvents as the mobile phase. Alternatively, the fluid drive 20 may comprise plural individual pumping units, with plural of the pumping units each receiving and pumping a different solvent or mixture, so that the mixing of the mobile phase (as received by the sample separation unit 30) occurs at high pressure and downstream of the fluid drive 20 (or as part thereof). The composition of the mobile phase may be kept constant over time, the so called isocratic mode, or varied over time, the so called gradient mode.

A data processing unit or control unit 70, which can be a PC or workstation, may be coupled (as indicated by the dotted arrows) to one or more of the devices in the sample separation apparatus 10 in order to receive information and/or control operation. For example, the control unit 70 may control operation of the fluid drive 20 (for example setting control parameters) and receive therefrom information regarding the actual working conditions (such as output pressure, etc. at an outlet of the pump 20). Optionally, the control unit 70 may also control operation of the solvent supply 25 (for example setting the solvent/s or solvent mixture to be supplied) and/or the degassing unit 27 (for example setting control parameters and/or transmitting control commands) and may receive therefrom information regarding the actual working conditions (such as solvent composition supplied over time, vacuum level, etc.). The control unit 70 may further control operation of the sampling unit or injector 40 (for example controlling sample injection or synchronization of sample injection with operating conditions of the fluid drive 20). The separation unit 30 may also be controlled by the control unit 70 (for example selecting a specific flow path or column, setting operation temperature, etc.), and send—in return—information (for example operating conditions) to the control unit 70. Accordingly, the detector 50 may be controlled by the control unit 70 (for example with respect to spectral or wavelength settings, setting time constants, start/stop data acquisition), and send information (for example about the detected sample compounds) to the control unit 70. The control unit 70 may also control operation of the fractionating unit 60 (for example in conjunction with data received from the detector 50) and provides data back.

Furthermore, FIG. 1 shows a sample container 102 containing a fluidic sample to be aspirated by the injector 40 for subsequent injection between the fluid drive 20 and the sample separation unit 30. Moreover, FIG. 1 illustrates different sample containers 102 into which different fractions of the separated fluidic sample are inserted in the fractionating unit 60. Both in the injector 40 and in the fractionating unit 60 handling of fluidic sample and sample containers 102 may occur. The subsequently described embodiments focus predominantly on sample handling in an injector 40 according to exemplary embodiments of the present disclosure. However, corresponding considerations apply to sample handling in the fractionating unit 60.

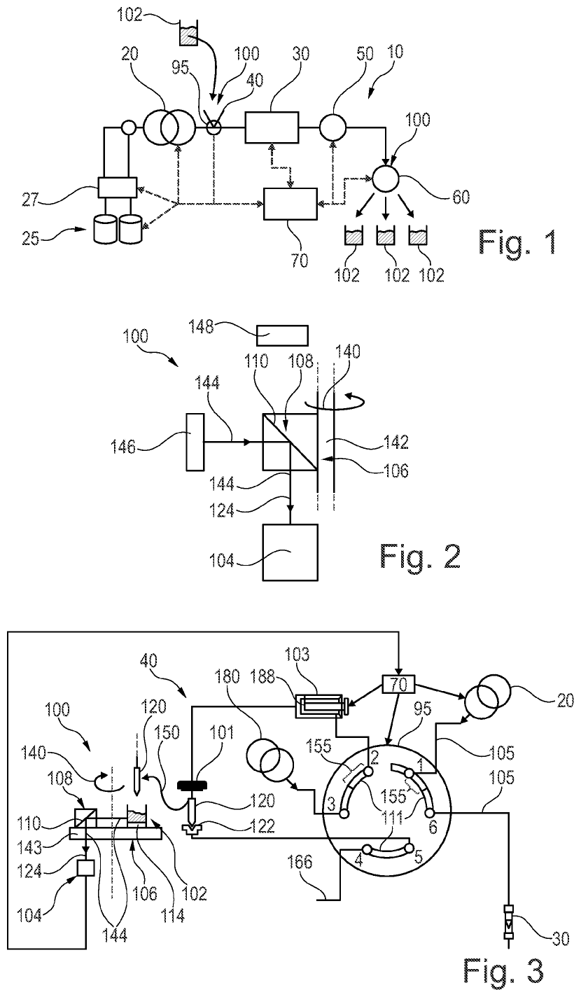

FIG. 2 shows a schematic view of a sample handler 100 according to an exemplary embodiment of the present disclosure implementable in the sample separation apparatus 10 of FIG. 1, for instance in injector 40 and/or in fractionating unit 60.

Hence, FIG. 2 illustrates a sample handler 100 for handling a sample container 102 (not shown in FIG. 2) which comprises a stationary, i.e. spatially fixed, optical sensor 104—such as a camera—having a fixed vertical viewing axis 124. Furthermore, the sample handler 100 comprises a movable stage 106 being movable with respect to the stationary optical sensor 104. More specifically, the movable stage 106 may be a rotatable stage configured for being rotatable around a vertical axis, see rotating arrow 140. Moreover, the sample handler 100 comprises an optical adapter 108 which is here mounted on a rotating shaft 142 of the movable stage 106 and which is configured for being rotated by the movable stage 106 to thereby adapt a view of the stationary optical sensor 104. In the configuration shown in FIG. 2, an electromagnetic radiation beam 144 may propagate from an object of interest 146 in a field of view of the optical sensor 104 via the optical adapter 108 towards the optical sensor 104. Hereby, the propagation of the electromagnetic radiation beam 144 is angled due to a (partial or entire) reflection of the electromagnetic radiation beam 144 at a reflective mirror, as passive optical element 110, of the optical adapter 108.

For example, the object of interest 146 may be a sample container 102 (see FIG. 1), fluidic sample in a sample container 102, a region or surface portion of the sample handler 100, or a region or surface of another constituent of the sample separation apparatus 10 (see again FIG. 1). In particular when embodied as a sample container 102, the object of interest 146 may be mounted on the movable stage 106 and may be rotated by the movable stage 106.

In the shown configuration, the optical sensor 104 senses the object of interest 146. When however the movable stage 106 is rotated away from the configuration shown in FIG. 2, the movable adapter 108 is removed from the vertical viewing axis 124 of the optical sensor 104, and another object of interest 148 (which may be arranged apart from the movable stage 106) will become detectable for the optical sensor 104. For example, the object of interest 148 may be another sample container 102, fluidic sample in another sample container 102, another region or surface portion of the sample handler 100, or another region or surface of another constituent of the sample separation apparatus 10.

Hence, by the provision of the movable adapter 108 in combination with the stationary optical sensor 104 with fixed viewing axis 124, the viewing trajectory of the stationary optical sensor 104 may be adapted or modified, so that one and the same optical sensor 104 may sense different objects of interest 146, 148 in different configurations of the optical adapter 108.

FIG. 3 illustrates details of an injector 40 (and connected components) as an example for a sample handler 100 according to an exemplary embodiment of the present disclosure. FIG. 3 shows a possible embodiment of the injector 40 of FIG. 1.

The injector 40 is configured for injecting a fluidic (here: liquid) sample into a flow path 105 between high pressure fluid drive 20 (configured for pumping mobile phase, i.e. a definable solvent composition) and separation unit 30, embodied as a chromatographic column. For the purpose of separating the fluidic sample into fractions, the injector 40 comprises a sample loop or sample accommodation volume 101 for accommodating a certain amount of the fluidic sample prior to injecting. A sample drive 103, which can be embodied as a metering pump or syringe pump, is configured for driving the fluidic sample from the sample accommodation volume 101 into the flow path 105, when fluidic valve 95 is switched into a corresponding switching state. For driving the fluidic sample towards the separation unit 30, a piston 188 of the sample drive 103 is controlled to move forwardly. Sample drive 103 is further configured for intaking fluidic sample from a sample container 102 into the sample accommodation volume 101 by a backward motion of the piston 188. The fluidic valve 95 can be switched in multiple switching states under control of control unit 70. By switching the fluidic valve 95, it is possible to selectively couple the sample accommodation volume 101 with the flow path 105 or decouple the sample accommodation volume 101 from the flow path 105. The control unit 70 may be configured for adjusting an outlet pressure value and/or an outlet volumetric flow rate value (alternatively an outlet mass flow rate value) according to which the mobile phase and the fluidic sample are driven to the separation unit 30.

The injector 40 comprises a needle 120 and a seat 122 configured for accommodating the needle 120. As indicated schematically by reference sign 150, the needle 120 is drivable towards a sample container 102 mounted on a movable stage 106 (such as a turntable) for intaking fluidic sample contained in the sample container 102 into the sample accommodation volume 101 by the sample drive 103. The needle 120 is furthermore configured to be drivable back to the seat 122 prior to injection. Reference numeral 166 indicates a waste, and reference sign 180 indicates an optional flush pump. The fluidic valve 95 comprises a rotor and a stator and may be switched by moving the rotor relative to the stator. As a result of this rotation, grooves 111, 155 and ports 1-6 may be brought in alignment or out of alignment to thereby establish or disable certain fluidic connections.

Now referring in detail to the sample handling function of the injector-type sample handler 100 according to FIG. 3, a CCD camera—as stationary optical sensor 104—is arranged spatially fixed beneath a turntable-type movable stage 106. On a plate 143 of the movable stage 106, a sample container 102 (here embodied as a sample vial) and an optical adapter 108 are mounted, for instance detachably mounted. The optical adapter 108 has a passive optical element 110, here embodied as reflective mirror for reflecting an electromagnetic radiation beam 144 propagating from fluidic sample in the sample container 102 on the movable stage 106. In the configuration shown in FIG. 3, the electromagnetic radiation beam 144 (for instance visible light) may be reflected at the passive optical element 110 and may be redirected towards the optical sensor 104 with its vertical viewing direction 124. The configuration according to FIG. 3 shows a scenario in which the needle 120 is ready for intaking fluidic sample from sample container 102. Due to the view of the stationary optical sensor 104 onto a side surface of sample container 102 as adjusted by the optical adapter 108, an image of the fluidic sample in the sample container 102 may be captured by the optical sensor 104. This image data may be supplied from the optical sensor 104 to the control unit 70. By image processing, the control unit 70 may assess whether the fluidic sample is in a proper condition for subsequent separation, or has an opaque appearance which may be an indicator for an issue with the sample. For instance, the image data provided by the optical sensor 104 and analyzed by the control unit 70 may be indicative of an undesired opacity, an undesired solid precipitation and/or a contamination of the fluidic sample. If such an issue is identified, the control unit 70 may take a corresponding action, for instance may stop an injection and separation process, output a warning to a user, etc. Thus, the injector 40 and in particular its control unit 70 may be configured for controlling injection of the fluidic sample based on information sensed by the optical sensor 104.

Since the movable stage 106 is rotatable, it can also be rotated (for instance under control of control unit 70 or by a user) into another configuration in which the sample container 102, which is mounted on the movable stage 106, is directly above or below the optical sensor 104 (not shown). In this configuration, the optical adapter 108, which is mounted as well on the movable stage 106, is located outside of an optical path sensible by the optical sensor 104. In this configuration, the optical sensor 104 can thus detect an image of a bottom of the sample container 102, where a code 114 (for instance a QR code) may be located. Thus, the viewing direction of the optical sensor 104 in the latter mentioned configuration allows to detect another information than the aforementioned configuration, thanks to the movably mounted optical adapter 108 which can be selectively brought in functional cooperation with or out of functional cooperation with the optical sensor 104.

More generally, it is possible that the optical sensor 104 is configured for sensing a property of a fluidic sample in the sample container 102, such as an opacity, a contamination, and/or an identifier (in particular via code 114). Although not shown, it is possible, additionally or alternatively, that the optical sensor 104 is configured for sensing a property of the sample handler 100 or a component thereof, in particular of needle 120 (for instance a deformed state of needle 120) and/or needle seat 122 (for example an undesired precipitation of salt at or around needle seat 122). When sensing a code 114 by the optical sensor 104, the control unit 70 may be configured for using and/or storing the identifier information for tracking the sample container 102 and/or a fluidic sample in the sample container 102 during a sample separation process.

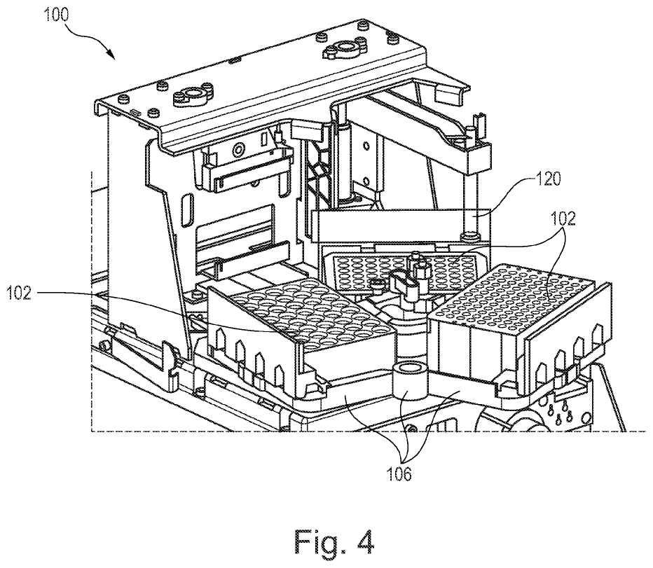

FIG. 4 shows a three-dimensional view of a sample handler 100 according to an exemplary embodiment of the present disclosure. The illustrated sample handler 100 is configured as injector 40 for injecting a fluidic sample from a sample container 102, as described above referring to FIG. 1 and FIG. 3. More specifically, FIG. 4 shows a rotary HPLC-autosampler with a movable stage 106 embodied as turntable and a needle arm with needle 120. Furthermore, FIG. 4 shows that three sample containers 102, which may for instance be embodied as microtiter plates or vial trays, are mounted on the movable stage 106. The needle 120 shown in FIG. 4 may be used for intaking fluidic sample from a sample container 102, and/or may be used in terms of the fractionating unit 60 for filling separated fluidic sample in sample containers 102. For example, the needle 120 may aspirate fluidic sample out of a vial, and the aspirated fluidic sample may then be separated after injection by sample separation unit 30 (not shown in FIG. 4). Hence, a direct sample intake with needle 120 is possible according to FIG. 4.

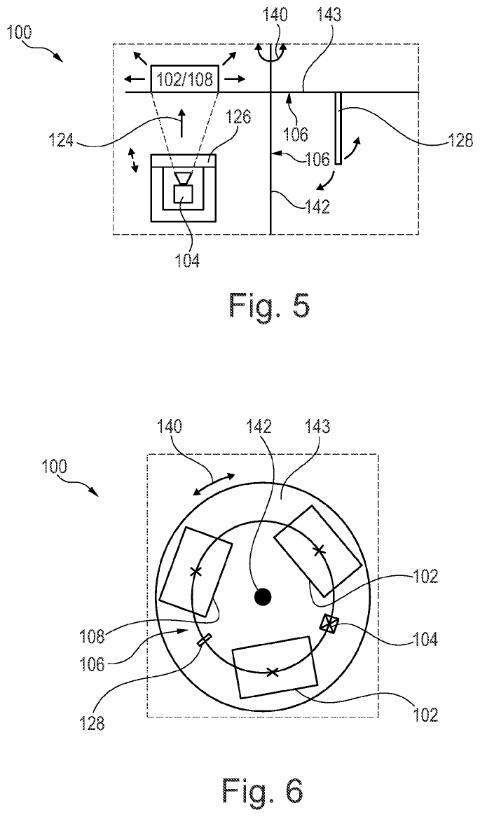

FIG. 5 shows a side view of a sample handler 100 for handling a sample container 102 with a fluidic sample therein according to an exemplary embodiment of the present disclosure. FIG. 6 shows a top view of a sample handler 100 according to FIG. 5.

The sample handler 100 comprises a camera-type stationary optical sensor 104, a movable stage 106 being rotatable with respect to the stationary optical sensor 104, and an optical adapter 108 arranged on the movable stage 106 and configured for being rotated by the movable stage 106 to thereby adapt a viewing trajectory of the stationary optical sensor 104. As shown, the movable stage 106 is configured for carrying and rotating sample containers 102. More specifically, the movable stage 106 comprises a turntable configured for turning the sample containers 102 together with the optical adapter 108. Each of the optical adapter 108 and the sample containers 102 may be detachably arranged at the movable stage 106. As shown, the movable stage 106 is configured to carry, such as in a detachable way, one or more sample containers 102 and one or more optical adapters 108, which may have the same footprints. As a result, each accommodation compartment of the movable stage 106 allows an accommodation of a sample container 102 or an optical adapter 108, for instance by a corresponding form closure at a bottom. Thus, a user may flexibly combine one or more sample containers 102 and one or more optical adapters 108 in accordance with a specific application.

The optical adapter 108 may comprise one or more passive optical components 110, such as reflective mirrors. Reference sign 152 indicates various possible viewing directions enabled by the mirrors functioning as intentional distortions (or reflections, deflections, redirections, etc.) of the optical path along which the optical sensor 104 can detect images.

In certain rotation configurations of the movable stage 106, in which the optical sensor 104 is located directly beneath a respective sample container 102, the optical sensor 104 is configured for sensing the sample container 102, for example by sensing a code (see reference sign 114 in FIG. 3) on a bottom of the respective sample container 102 in a configuration without the optical adapter 108 between bottom of the sample container 102 and optical sensor 104. As shown, the camera-type optical sensor 104 has a direct view to the bottom side of the sample containers 102 and therefore can scan barcodes (not shown in FIG. 5 and FIG. 6) that may be placed on the bottom of the sample containers 102 (for instance vials or well plates).

When one or more mirrors of one or more optical adapters 108 is or are placed in free spaces between the sample containers 102, it is possible to deflect the light and get a distorted (or reflected, deflected, redirected, etc.) picture of different viewing directions. The turntable-type movable stage 106 may rotate the mirrors with respect to the camera, while the camera has a fixed position. Due to the mirrors, it may be possible to generate an optical path to an external sample container 102 (such as a vial tray), the needle seat 122, and/or to sides of the sample containers 102 (such as well plates, vial trays, vials) that are placed in front of such a mirror (for example with a gripper).

As shown in FIG. 5 and FIG. 6, the optical sensor 104 has, but not necessarily, a vertical viewing axis 124. Moreover, the optical sensor 104 is arranged below the movable stage 106. Consequently, the optical sensor 104 is protected below the movable stage 106 against contamination and mechanical impact. Thus, the camera-type optical sensor 104 is placed under the turntable-type movable stage 106 and is looking upwards, thereby facing the bottom side of the sample containers 102 (for instance well plates, vial trays and/or vials).

In order to further improve the reliability of the optical sensor 104, it may be provided with a slidable protection cover 126 being operable by a pusher 128 mounted as a protrusion on the bottom side of the movable stage 106, for selectively covering the optical sensor 104 in a passive protection mode or for exposing the optical sensor 104 in an active sensing mode. More specifically, the optical sensor 104 may be normally closed by the protection cover 126. When the movable stage 106 rotates, the pusher 128 may reach the protection cover 126 and may displace it relative to the rest of the optical sensor 104, thereby exposing a sensor active surface of the optical sensor 104 for subsequent optical detection. After optical sensing, the pusher 128 may again be operated to again cover the optical sensor 104 by sliding the cover 126 back into the covered configuration. For example, cover 126 may be moved perpendicular to the paper plane of FIG. 5 when impacted by the pusher 128. Pusher 128 may thus be operated for sliding the cover 126 of the optical sensor 104 open, and may thereby rotate towards the cover 126 when rotating the movable stage 106.

If one or more mirrors and/or one or more other passive optical components 110 is or are used in the optical adapter 108, a cover (not shown) may be added to the optical adapter 108 for protecting the passive optical component(s) 110 temporarily when not in use. For example, such a cover of an optical adapter 108 can be operated by a robot, gripper, or by a needle 120.

Although not shown, the optical sensor 104 may be equipped, additionally or alternatively to the provision of the cover 126, with a cleaning unit. For example, such a cleaning unit may comprise one or more brushes and/or one or more squeegees (not shown) configured for moving relative to the optical sensor 104 to mechanically impact the optical sensor 104 for cleaning.

The provision of a cover 126 and/or a cleaning unit may properly protect the optical sensor 104 from contamination and may thereby improve the reliability of the sample handler 100. When fixed to the movable stage 126, the pusher 108, the one or more brushes and/or the one or more squeegees may be moved automatically by the rotation of movable stage 126. Any additional actuator or motion mechanism may thus be dispensable.

Hence, to protect the camera-type optical sensor 104 from dust, humidity and leakage, etc., it is possible to add a slidable cover 126 on top of the camera. Pusher 128 that is attached to the bottom of the turntable can push the edge of the cover 126 and open it (rotating in one direction) and also can close it again when rotated in the other direction (for example, a whole turn can be carried out until the pusher 128 approaches the edge of the cover 126 from the opposite side). Additionally, brushes can be attached to the inside of the cover 126, that can clean a lens of the camera with every opening or closing of the cover 126.

It is also possible to protect the camera with a window on top of the camera box (for instance by an encapsulation). This window can be cleaned by a squeegee that is moved in a corresponding way as described for the brushes. A cover or covers for the mirrors on top of the turntable can also be implemented and moved, for instance by the needle arm or gripper (in combination with the rotation of the turntable).

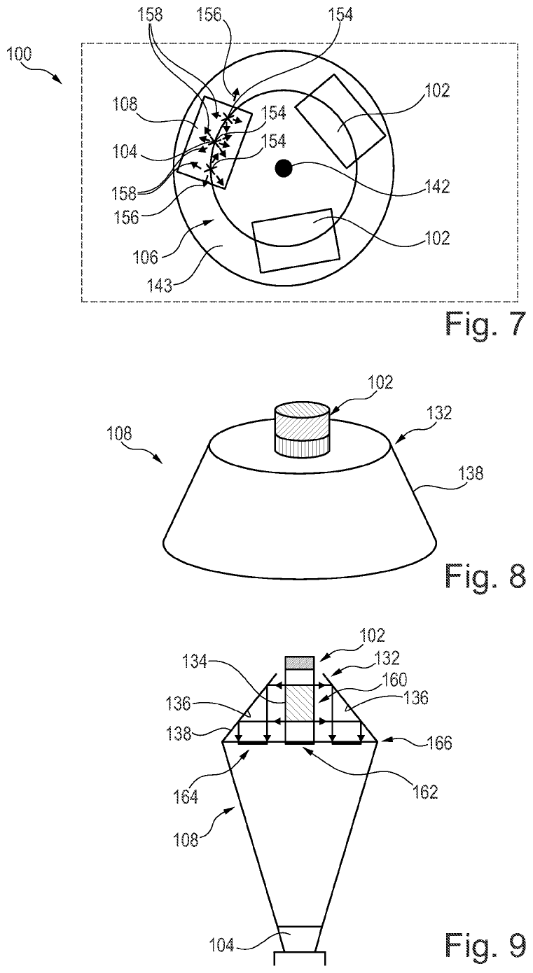

FIG. 7 shows a top view of a sample handler 100 according to another exemplary embodiment of the present disclosure. According to FIG. 7, reference signs 154 represent possible positions of the turntable-type movable stage 106 that can be brought to the camera-type optical sensor 104 that has a fixed position. Arrows 156 show possible moving directions of the turntable, and arrows 158 show possible optical paths.

In one embodiment, an optical adapter 108 may be integrated into the turntable (or any other movable stage 106). However, the flexibility may be increased and space restrictions may be relaxed when embodying the optical adapter 108 detachable from the movable stage 106. Hence, it may be advantageous to integrate the optical setup (for instance the optical adapter 108, which may comprise one or more mirrors and/or a sample container holder 132, which may also be denoted as optical vial holder and will be described below referring to FIG. 8 to FIG. 11) partially or entirely into the movable stage 106. When the optical adapter 108 is integrated into the footprint (and for example placed at one of, in this embodiment three, possible vial tray or well plate positions of the turntable) more space is available. Moreover, such an approach is highly modular and may render it dispensable to implement an optical adapter 108 fixed in a basic sampler instrument. Several different setups are also possible (for example different vial holders for different sizes of vials, etc.). For sensible applications, two optical adapters 108 and only one sample container 102 (for example a well plate or a vial tray) is also possible.

When a sample container 102 is configured as a well plate or vial tray, such a sample container 102 can be detected by the optical sensor 104 embodied as camera system if a code (for example a linear barcode, a QR code, and/or a data matrix) is placed on the bottom of the sample container 102. Correspondingly, also a bottom of the optical adapter 108 may be provided with a code (for example a linear barcode, a QR code, and/or a data matrix) to be detected by the optical sensor 104.

FIG. 7 shows a configuration with an optical adapter 108 that can be placed on the turntable-type movable stage 106 instead of sample container 102 (such as a well plate or vial tray).

If the optical adapter 108 is realized within a container, the above mentioned pusher 128 can also be realized with that container, and therefore the sampler setup does not have movement restrictions. With this realization, it is also possible to detect that an optical adapter 108 is present. For example, it may be possible to detect a movement restriction through the contact between camera cover 126 and pusher 128.

Additionally, it may be possible to remove and clean the optical adapter 108 easily when realized as container being a separate body mountable in a detachable way on movable stage 106.

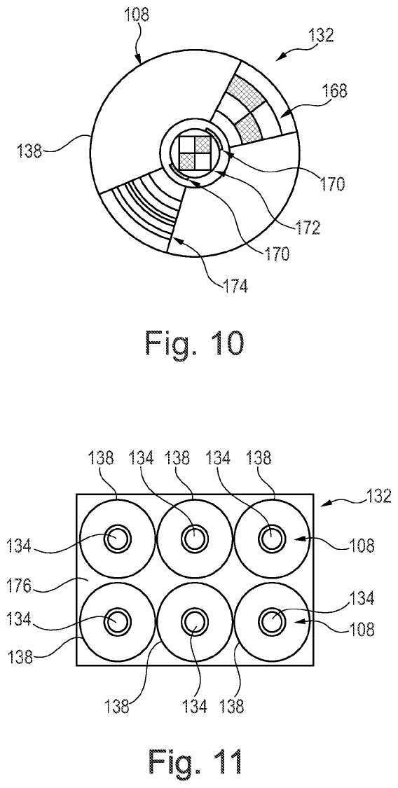

FIG. 8 shows a three-dimensional view of a sample container holder 132 for a sample handler 100 according to an exemplary embodiment of the present disclosure. FIG. 9 shows a cross-sectional view of the sample container holder 132 of FIG. 8 together with an optical sensor 104 cooperating therewith. FIG. 10 shows an optical pattern sensed by the optical sensor 104 in a configuration as shown in FIG. 9.

More specifically, FIG. 8 to FIG. 10 show that the optical adapter 108 may be embodied as a sample container holder 132 having an accommodation volume 134 for accommodating a lower part of the sample container 102. Furthermore, the sample container holder 132 may have an internal optical configuration enabling the optical sensor 104 for sensing a vial-type sample container 102 when accommodated in the accommodation volume 134. As best seen in FIG. 9, the sample container holder 132 has an optically reflective inner surface 136 for reflecting electromagnetic radiation (such as light, in particular visible light) propagating from the sample container 102 to the optical sensor 104. More specifically, the internal optical configuration of the sample container holder 132 comprises a reflective mirror cone.

The sample container holder 132 is embodied an annular body 138 having a central opening defining the accommodation volume 134 for accommodating the for instance tubular sample container 102. More specifically, reference sign 138 shows a vial holder ring with reflective inner surface. As shown in FIG. 9, the sample container holder 132 is configured for receiving the sample container 102 from above, whereas the optical sensor 104 is arranged below the sample container holder 132.

In the embodiment according to FIG. 8 to FIG. 10, the sample container holder 132 may be provided as a stand-alone body which can be detachably mounted on a corresponding mounting provision of a movable stage 106 to function as optical module 108. The sample container holder 132 may then be rotated together with the movable stage 106 and relative to the stationary optical sensor 104. In another embodiment, the sample container holder 132 may also be integrally formed with a movable stage 106 as a common body, in particular may be integrated in a plate 143 thereof.

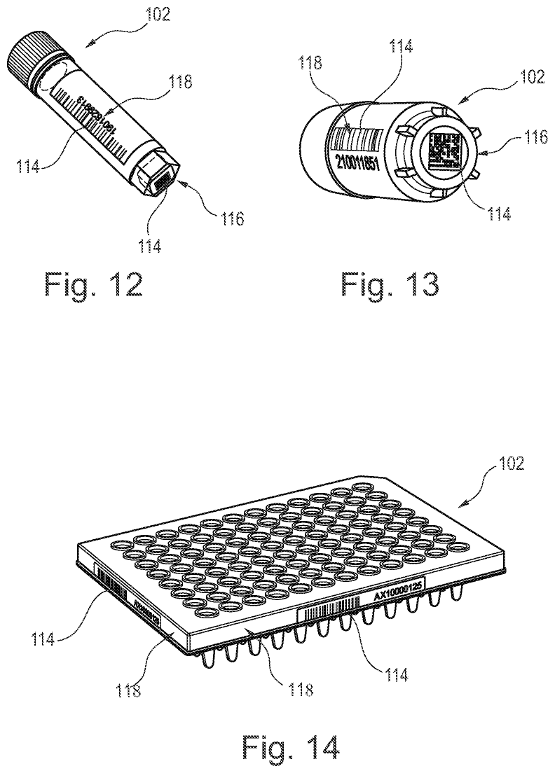

In the configuration according to FIG. 9, the optical sensor 104 is configured for sensing two different codes 114 on the sample container 102. Such codes 114 may be one or more linear barcodes and/or one or more QR codes on the sample container 102. Due to the spatial arrangement according to FIG. 8 to FIG. 10, the optical sensor 104 is configured for sensing a plurality of such codes 114 on a bottom surface 116 and on a side surface 118 (compare FIG. 12 and FIG. 13) of the sample container 102 simultaneously when the sample container 102 is accommodated in the accommodation volume 132.

More specifically, FIG. 9 indicates a position of a code 114 on a side surface 118 of the sample container 102 with reference sign 160. A position of a code 114 on the bottom surface 116 of the sample container 102 is indicated with reference sign 162 in FIG. 9. Reference sign 164 indicates a projection of a code 114 on side surface 118. A transparent bottom of the sample container holder 132 (here embodied as vial holder) is shown with reference sign 166.

Now referring to FIG. 10, a bottom view of the sample container holder 132 of FIG. 8 and FIG. 9 is shown, i.e. a view as detected by camera-type optical sensor 104 according to FIG. 9. Reference sign 168 shows a distorted projection of a two-dimensional code on the side surface 118 of the vial-type sample container 102. Reference sign 170 shows possible code positions on the side surface 118 of the vial-type sample container 102. Reference sign 172 shows an image of a two-dimensional code on the bottom 116 of the vial-type sample container 102. Reference sign 174 shows a distorted protection of a one-dimensional code on the side surface 118 of the vial-type sample container 102.

Thus, the embodiment of FIG. 8 to FIG. 10 shows a sample container holder 132 embodied as a vial holder for combined side and bottom 1D/2D-code reading.

For tracking reasons, sample containers 102 such as vials can have codes 114. These codes 114 may be located on the bottom 116 (for instance 2D codes like a QR-code or a data matrix) and/or or the side surface 118 of the sample container 102 (for example 2D or 1D barcodes).

According to exemplary embodiments, such as the one shown in FIG. 8 to FIG. 10, it may be made possible to also read a plurality of codes 114 at different locations of a sample container 102 simultaneously. For this purpose, the optical sensor 104 may capture a combined bottom-side surface-image, as shown in FIG. 10. Such an approach is significantly less complicated than conventional approaches, and may neither require the vial to be placed in the right orientation nor be limited to one of different possible code positions (i.e. on bottom 116 and on the side surface 118).

As shown in FIG. 9, an upwards looking camera may be used as optical sensor 104 and may be placed under the vial holder in form of sample container holder 132. Codes 114 on the bottom 116 of the vial-type sample container 102 can be scanned directly with the camera-type optical sensor 104. To read further codes 114 on the side surface 118 of the vial-type sample container 102, the same setup can be used when an additional mirror cone is implemented within the illustrated sample container holder 132. The image from the side surface 118 of the sample container 102 is projected onto the bottom side of the sample container holder 132 and can be scanned by the same camera-type optical sensor 104, independent of the actual position of the code 114 on the surface of the sample container 102.

FIG. 11 shows a plan view of a sample container holder 132 for a sample handler 100 according to another exemplary embodiment of the present disclosure.

According to FIG. 11, the sample container holder 132 has further accommodation volumes 134 each for accommodating an upper part of a respective further sample container 102 and has an internal optical configuration enabling the optical sensor 104 (or one or more further optical sensors 104) for sensing further sample containers 102 when accommodated in the further accommodation volumes 134. Descriptively speaking, the sample container holder 132 according to FIG. 11 is a matrix-like array of individual sample container holders 132 according to FIG. 8 to FIG. 10 in a common support body 176.

Hence, several of the vial holders according to FIG. 8 to FIG. 10 are integrated within a common vial tray according to FIG. 11, so that several vial-type sample containers 102 with codes 114 can be scanned by one or more camera-type optical sensors 104 at the same time.

FIG. 12 shows a vial-type sample container 102 with a code 114 on a side surface 118 and a further code 114 on a bottom surface 116 for a sample container holder 132 according to an exemplary embodiment of the present disclosure, for instance according to FIG. 8 to FIG. 11. FIG. 13 shows another vial-type sample container 102 with a code 114 on a side surface 118 and a further code 114 on a bottom surface 116 for a sample container holder 132 according to an exemplary embodiment of the present disclosure, for instance according to FIG. 8 to FIG. 11.

FIG. 14 shows a well plate-type sample container 102 with a code 114 on a side surface 118 and a further code 114 on a further side surface 118. The sample container 102 according to FIG. 14 can be used in combination with an optical sensor 104 and an optical adapter 108, the latter being able to redirect an optical view of the optical sensor 104 so that both codes 114 according to a FIG. 14 can be detected by the same optical sensor 104 in two different configurations of the optical adapter 108.

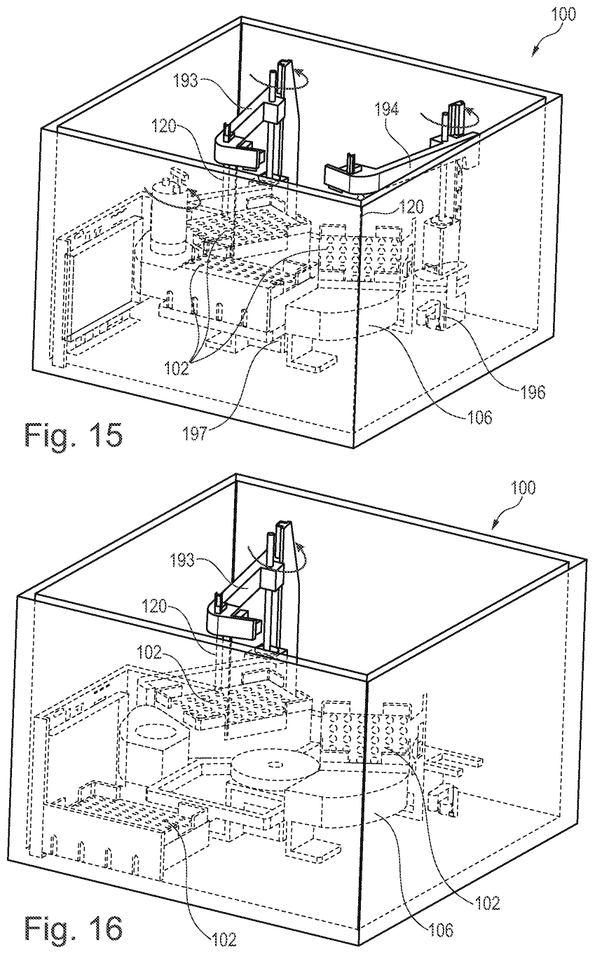

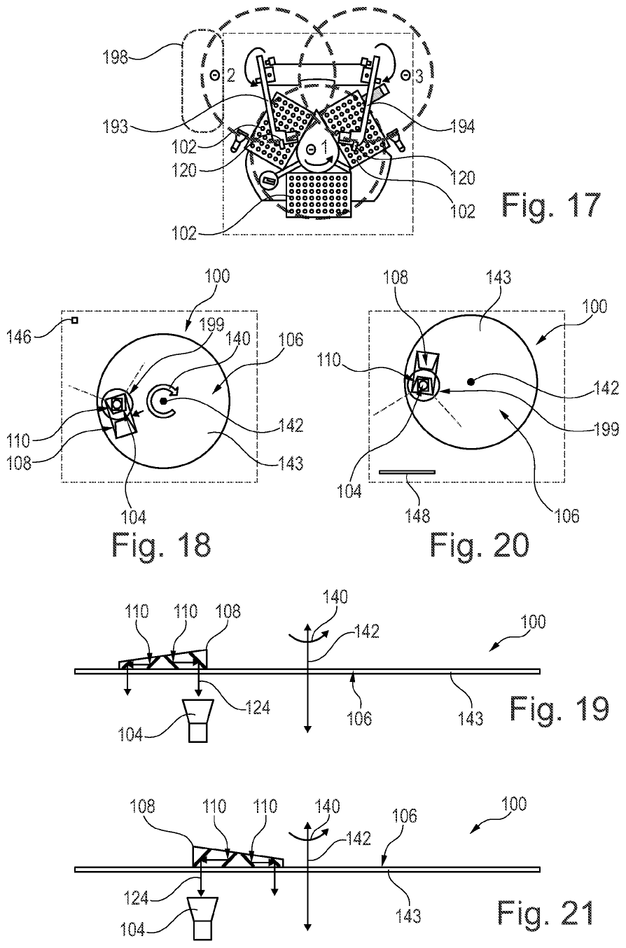

FIG. 15 and FIG. 16 show three-dimensional views of a sample handler 100 according to another exemplary embodiment of the present disclosure. FIG. 17 shows a plan view of the sample handler 100 of FIG. 15 and FIG. 16.

The sample handler 100 according to FIG. 15 to FIG. 17 has three rotation axes which may be operated independently of each other. A first rotation axis relates to rotation of a first arm 193. A second rotation axis relates to rotation of a second arm 194. Both arms 193, 194 are configurable as needle 120 or gripper. The three-axis sample handler 100 according to FIG. 15 to FIG. 17 may allow the parallel execution of a plurality of handling tasks. Three corresponding rotation angles θ1, θ2, θ3 may be adjusted or controlled individually.

The sample handler 100 according to FIG. 15 to FIG. 17 in particular allows a rotation of a sample carousel with a three-axis robotic arm. An imaging system may be used to read out codes 114 (such as barcode, QR code, etc.), detect a liquid level, etc. The sample handler 100 with its three-axis functionality may for instance allow for a combination of an injector 40 and a fractionator unit 60, or simultaneous injection of fluidic sample and gripping.

A wash port 196, a drive 197, and an area external tray 198 are illustrated as well. Furthermore, the sample handler 100 according to FIG. 15 to FIG. 17 may be fully automated and/or may be controlled via a user interface.

FIG. 18 shows a plan view of a sample handler 100 according to another exemplary embodiment of the present disclosure. FIG. 19 show a side view of the sample handler 100 according to FIG. 18. According to FIG. 18 and FIG. 19, an object of interest 146 or item to inspect is detected by a stationary optical sensor 104 cooperating with an optical adapter 110 having reflective mirrors 110 and being mounted on a rotatable stage 106, embodied as plate carousel. A field of view (in particular of conical shape) of the camera-type optical sensor 104 is shown with reference sign 199. As can be taken from FIG. 18 and FIG. 19, the optical adapter 108 may manipulate an optical path detectable by the optical sensor 104 so that the object of interest 146 may be detected.

FIG. 20 shows a plan view of a sample handler 100 according to still another exemplary embodiment of the present disclosure. FIG. 21 show a side view of the sample handler 100 according to FIG. 20. The embodiment of FIG. 20 and FIG. 21 differs from the embodiment of FIG. 18 and FIG. 19 by a different spatial configuration of the optical adapter 110. As can be taken from FIG. 20 and FIG. 21, the optical adapter 108 may manipulate an optical path detectable by the optical sensor 104 in another way as compared to FIG. 18 and FIG. 19 so that the object of interest 148 may be detected.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 70 schematically depicted in FIGS. 1 and 3. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 70 schematically depicted in FIGS. 1 and 3), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

1. A sample handler for handling a sample container, the sample handler comprising:
a stationary optical sensor;
a movable stage being movable with respect to the stationary optical sensor; and
an optical adapter configured to be arranged at the movable stage and configured to be moved by the movable stage to thereby adapt a view of the stationary optical sensor.

2. The sample handler according to claim 1, wherein the movable stage is configured to carry and move the sample container.

3. The sample handler according to claim 1, wherein the movable stage comprises a turntable configured to turn the sample container together with the optical adapter.

4. The sample handler according to claim 1, wherein the movable stage is configured to rotate the optical adapter.

5. The sample handler according to claim 1, wherein the optical adapter and/or the sample container is or are detachably arranged or arrangeable at the movable stage.

6. The sample handler according to claim 1, wherein the optical adapter comprises at least one passive optical component.

7. The sample handler according to claim 1, wherein the optical adapter comprises at least one mirror.

8. The sample handler according to claim 1, wherein the optical sensor is configured as a camera.

9. The sample handler according to claim 1, wherein the optical sensor is configured to sense the sample container.

10. The sample handler according to claim 1, wherein the optical sensor is configured to sense at least one code on the sample container.

11. The sample handler according to claim 10, comprising at least one of the following features:
wherein the optical sensor is configured to sense a barcode on the sample container;
wherein the optical sensor is configured to sense the at least one code on the sample container via the optical adapter;
wherein the optical sensor is configured to sense the at least one code on a bottom surface and/or on a side surface of the sample container.

12. The sample handler according to claim 1, comprising at least one of the following features:
wherein the optical sensor is configured to sense a property of the sample handler or a component thereof;
wherein the optical sensor is configured to sense a needle and/or a needle seat of the sample handler;
wherein the optical sensor is configured to sense a property of a fluidic sample in the sample container;
wherein the optical sensor is configured to sense a property of a fluidic sample comprising at least one of: an opacity; a precipitation; a contamination;
comprising the sample container;
comprising the sample container, wherein the sample container comprises at least one of: a sample vial; a well plate; a vial tray;
wherein the movable stage is configured to carry any of the sample container and the optical adapter;
wherein the movable stage is configured to carry any of the sample container and the optical adapter, and the sample container and the optical adapter have the same footprints;
wherein the optical sensor is arranged with a vertical viewing axis;
wherein the optical sensor is arranged below the movable stage;
wherein the optical sensor comprises a movable protection cover being actuatable to selectively cover the optical sensor in a passive protection mode or for exposing the optical sensor in an active sensing mode;
wherein the optical sensor comprises a movable protection cover being actuatable, by a pusher mounted on the movable stage or on the optical adapter, to selectively cover the optical sensor in a passive protection mode or to expose the optical sensor in an active sensing mode;
comprising a cleaning unit configured to move relative to the optical sensor to mechanically impact the optical sensor for cleaning.

13. The sample handler according to claim 1, comprising at least one of the following features:
the sample handler is configured as injector configured to inject a fluidic sample from the sample container for subsequent separation;
the sample handler is configured as fractionator unit configured to collect a separated fluidic sample in the sample container.

14. The sample handler according to claim 13, comprising at least one of the following features:
wherein the injector is configured to inject the fluidic sample from the sample container into a fluidic path between a fluid drive and a sample separation unit of a sample separation apparatus;
wherein a control unit for controlling the injector is configured to control injection of the fluidic sample based on information sensed by the optical sensor.

15. The sample handler according to claim 1, comprising one of:
a control unit configured to identify, use and/or store information sensed by the optical sensor for tracking at least one selected from the group consisting of: the sample container; a fluidic sample in the sample container; and a sample separation process;
a control unit configured to identify, use and/or store information sensed by the optical sensor, the information being included in at least one code of the sample container, for tracking at least one selected from the group consisting of: the sample container; a fluidic sample in the sample container; and a sample separation process.

16. The sample handler according to claim 1, wherein the optical adapter comprises a sample container holder comprising an accommodation volume for accommodating at least part of the sample container and comprising an internal optical configuration enabling the optical sensor to sense a sample container when accommodated in the accommodation volume.

17. The sample handler according to claim 16, comprising at least one of the following features:
wherein the sample container holder has an optically reflective inner surface for reflecting electromagnetic radiation propagating between the sample container and the optical sensor;
wherein the sample container holder comprises an annular body having a central opening defining the accommodation volume;
wherein the internal optical configuration of the sample container holder comprises a reflective mirror cone;
wherein the sample container holder is configured for receiving the sample container from above, whereas the optical sensor is arranged below the sample container holder;
wherein the optical sensor is configured to sense at least one code of the sample container when accommodated in the accommodation volume;
wherein the optical sensor is configured to sense simultaneously a plurality of codes on a bottom surface and/or on a side surface of the sample container when accommodated in the accommodation volume;
wherein the sample container holder comprises at least one further accommodation volume for accommodating at least part of at least one further sample container and comprises an internal optical configuration enabling the optical sensor or at least one further optical sensor to sense at least one further sample container when accommodated in the at least one further accommodation volume.

18. A sample separation apparatus for separating a fluidic sample, the sample separation apparatus comprising:
a fluid drive for driving a mobile phase and the fluidic sample when injected in the mobile phase;
a sample separation unit for separating the fluidic sample in the mobile phase; and
the sample handler according to claim 1 for handling the sample container containing fluidic sample.

19. The sample separation apparatus according to claim 18, further comprising at least one of the following features:
the sample separation apparatus is configured as a chromatography sample separation apparatus;
the sample separation apparatus is configured as a a liquid chromatography sample separation apparatus;
the sample handler is configured as injector for injecting a fluidic sample from the sample container;
the sample handler is configured as fractionator unit configured to collect a separated fluidic sample in the sample container;
the sample separation apparatus comprises a detector configured to detect the separated fluidic sample.

20. A method of operating a sample handler for handling a sample container, the method comprising:
arranging an optical sensor in a spatially fixed configuration;
moving a movable stage with respect to the stationary optical sensor; and
arranging an optical adapter at the movable stage for being moved by the movable stage to thereby adapt a view of the stationary optical sensor.
